(19) United States
(12) Patent Application Publication
(10) Pub. No.: US 2024/0282031 A1
(43) Pub. Date: Aug. 22, 2024

(54) ANIMATION DISPLAY METHOD AND APPARATUS, AND DEVICE

(71) Applicant: Beijing Bytedance Network Technology Co., Ltd., Beijing (CN)

(72) Inventors: Shengchuan SHI, Beijing (CN); Aoyu WANG, Beijing (CN); Bowen LUO, Beijing (CN); Zehua BAO, Beijing (CN)

(21) Appl. No.: 18/571,129

(22) PCT Filed: Sep. 21, 2022
(86) PCT No.: PCT/CN2022/120159

§ 371 Date: Dec. 15, 2023

(30) Foreign Application Priority Data
Sep. 30, 2021 (CN) 202111163674.X

(51) Int. Cl. G06T 13/20; G06T 19/00

(52) U.S. Cl. CPC G06T 13/20; G06T 19/006

(57) ABSTRACT

An animation display method, an apparatus and a device are provided. In the animation display method provided by the present application, the terminal device can be firstly moved along the target trajectory segment by the user. Then, the trajectory parameter set collected by the terminal device on the target trajectory segment can be obtained. The trajectory parameter set can include a plurality of groups of trajectory parameters. And then, the target model can be displayed at the display position corresponding to the target trajectory segment on the terminal device. In this way, because the display position of the target model is determined according to the target trajectory segment that the terminal device has moved along and the terminal device will be constrained by the real object during the moving process, the animation of the target model will also be constrained by the real object.

### CROSS-REFERENCE TO RELATED APPLICATION

The present disclosure claims priority of the Chinese Patent Application No. 202111163674.X filed to China National Intellectual Property Administration on Sep. 30, 2021 and entitled “Animation Display Method, Apparatus and Device”, the content of which is incorporated herein by reference in its entirety.

### TECHNICAL FIELD

The present application relates to the computer field, and in particular, to an animation display method, apparatus and device.

### BACKGROUND

Augmented Reality (AR) technology is a kind of technology that skillfully fuses virtual information with the real world. In the process of applying AR technology, a virtual object can be simulated to obtain an animation corresponding to the virtual object, and the animation obtained by simulation can be superimposed with the picture in the real world for display. In this way, the image appearing in the user's field of vision includes not only the picture of the real world, but also the animation corresponding to the virtual objects, so that the user can see the virtual object and the real world at the same time. The AR technology has been widely used in many fields thanks to the characteristics of strong interactiveness and good interactivity, etc.

Especially, through AR technology, the interaction between the virtual object and the real object in the real world can be simulated. For example, through AR technology, the display effect that a certain virtual object collides with a real object during motion can be realized. In this way, the combination and interaction combination between the virtual world and the real world is realized through AR technology, which can bring better display effect.

However, in order to realize the interaction between the virtual object and the real object, it is necessary to model the real object. However, the modeling process is often complicated, which will consume a lot of manpower and material resources and increase the application cost of AR technology.

### SUMMARY

In order to solve the problems in the prior art, embodiments of the present application provide an animation display method and apparatus.

In a first aspect, the embodiment of the present application provides an animation display method, the method includes:
obtaining a trajectory parameter set corresponding to a target trajectory segment, wherein the target trajectory segment is a trajectory segment passed by a terminal device during a motion process, the trajectory parameter set includes a plurality of groups of trajectory parameters, and the trajectory parameters are collected by the terminal device during motion of the target trajectory segment;
displaying an animation corresponding to a target model at a display position corresponding to the target trajectory segment on the terminal device, wherein the target model is determined according to a motion parameter, the motion parameter is determined according to the trajectory parameter set, and the motion parameter reflects a motion state feature of the terminal device on the target trajectory segment.

In a second aspect, the embodiment of the present application provides an animation display apparatus, the apparatus includes:
an obtaining unit, configured to obtain a trajectory parameter set corresponding to a target trajectory segment, wherein the target trajectory segment is a trajectory segment passed by a terminal device during a motion process, the trajectory parameter set includes a plurality of groups of trajectory parameters, and the trajectory parameters are collected by the terminal device during motion of the target trajectory segment;
a display unit, configured to display an animation corresponding to a target model at a display position corresponding to the target trajectory segment on the terminal device, wherein the target model is determined according to a motion parameter, the motion parameter is determined according to the trajectory parameter set, and the motion parameter reflects a motion state feature of the terminal device on the target trajectory segment.

In a third aspect, the embodiment of the present application provides an electronic device, the electronic device includes: one or more processors; a memory, configured to storing one or more programs; the one or more programs, when executed by the one or more processors, cause the one or more processors to realize the animation display method as mentioned in the first aspect.

In a fourth aspect, the embodiment of the present application provides a computer-readable storage medium, on which a computer program is stored, the program, when executed by a processor, realizes the animation display method as mentioned in the first aspect.

In the animation display method provided by the embodiment of the present application, the terminal device can be firstly moved along the target trajectory segment by the user. Then, the trajectory parameter set collected by the terminal device on the target trajectory segment can be obtained. The trajectory parameter set can include a plurality of groups of trajectory parameters. And then, the target model can be displayed at the display position corresponding to the target trajectory segment on the terminal device. In this way, because the display position of the target model is determined according to the target trajectory segment that the terminal device has moved along and the terminal device will be constrained by the real object during the moving process, the animation of the target model will also be constrained by the real object. In this way, without modeling the real object, a corresponding virtual model can be created based on the real object, and the interaction between the virtual object and the real object is realized. In addition, because the target model is determined according to the trajectory parameters of the target trajectory segment, the user only needs to adjust the movement of the terminal device on the target trajectory segment to adjust the animation display effect corresponding to the target trajectory segment. In this way, the user's free choice of virtual animation is realized, and the user experience is improved.

### BRIEF DESCRIPTION OF DRAWINGS

In order to more clearly explain the embodiments of this application or the technical scheme in the prior art, the drawings needed to be used in the description of the embodiments or the prior art will be briefly introduced below. Obviously, the drawings in the following description are some embodiments of this application, and other drawings can be obtained according to these drawings without creative work for ordinary people in the field.

FIG. 1 is a schematic scene diagram of an application scene of AR technology provided by the present application;

FIG. 2 is a flowchart of an animation display method provided by the present application;

FIG. 3 is a schematic diagram of a display interface of a terminal device provided by an embodiment of the present application;

FIG. 4 is a schematic structural diagram of an animation display apparatus provided by an embodiment of the present application; and

FIG. 5 is a schematic structural diagram of an electronic device provided by an embodiment of the present application.

### DETAILED DESCRIPTION

Embodiments of the present application will be described in more detail below with reference to the accompanying drawings. Although some embodiments of the present application are shown in the drawings, it should be understood that the present application can be realized in various forms and should not be construed as limited to the embodiments set forth here. On the contrary, these embodiments are provided for a more thorough and complete understanding of the present application. It should be understood that the drawings and examples of this application are only used for illustrative purposes, and are not used to limit the protection scope of this application.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

AR technology can combine the virtual world and the real world, and has been widely used in many fields. For example, through AR technology, the display effect that a virtual little human walks on a desktop can be realized, and the display effect that the virtual little human cannot move forward when hitting a wall can also be realized. In this way, to a certain extent, the “dimension wall” between the virtual world and the real world has been broken, and it has a good display effect and has been widely used in many fields.

However, for traditional AR technology, in order to realize the interaction between the virtual object and the real object, it is necessary to model the real object. Only by simulating the location of the real object can the interaction between the virtual object and the real object be realized. That is to say, in order to create a virtual object associated with a real object, it is necessary to firstly establish a virtual model corresponding to the real object.

For example, in order to achieve the display effect that “the virtual little human cannot move forward when hitting a wall”, the real object “wall” can be modeled first, a virtual object corresponding to the wall can be created in the virtual environment, and a collision relationship between the virtual object corresponding to the wall and the virtual little human can be set. During display, the virtual object corresponding to the wall may not be displayed. In this way, the picture viewed by the user includes the virtual little human and the real wall. When the virtual little human moves to a position corresponding to the real wall, it will collide with the virtual object corresponding to the wall and cannot move forward. In this way, the display effect that “the virtual little human cannot move forward when hitting a wall” is realized.

Obviously, the process of modeling a real object is complicated and needs to consume a lot of manpower and material resources; and when the environment changes, the original virtual model cannot continue to be used. In this way, not only the cost of using AR technology is increased, but also the application environment of AR technology is limited.

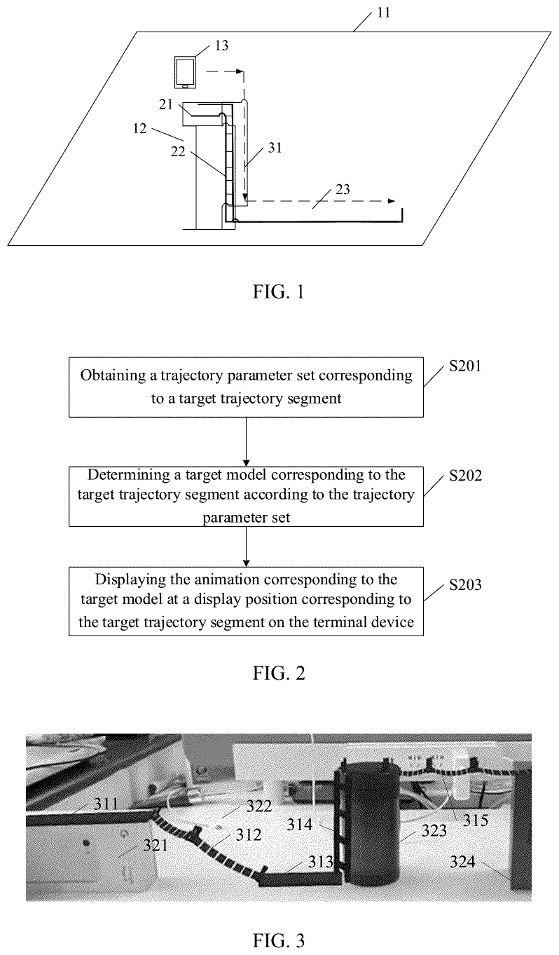

Referring to FIG. 1, it is a schematic scene diagram of an application scene of AR technology provided by an embodiment of the present application. The real world includes a plane 11 and an object 12 placed on the plane 11. The terminal device 13 is deployed with software related to AR technology, which can realize the display effect of interaction between the real world and the virtual object.

Optionally, it is assumed that the display effect that the terminal device needs to achieve is “track 21-track 22-track 23”, which is a track in contact with the object 12 and the plane 11. Then, in traditional AR technology, a virtual model corresponding to the plane 11 and a virtual model corresponding to the object 12 can be established respectively. Next, based on the virtual model corresponding to the plane 11 and the virtual model corresponding to the object 12, models corresponding to the tracks 21, 22 and 23 can be established, respectively, and corresponding animations can be displayed at the display positions corresponding to the models. For example, the model corresponding to the track model 21 can be deployed on the upper surface of the virtual model corresponding to the object 12, the model corresponding to the track model 22 can be deployed on the right side of the virtual model corresponding to the object 12, and the model corresponding to the track model 23 can be deployed on a corresponding position of the virtual model corresponding to the plane 11.

It can be seen that in traditional AR technology, the real object can be modeled to simulate the interaction between the virtual object and the real objects. Obviously, the more complex the real object, the more complicated the model needing to be established, and the higher the cost of realizing AR display. In addition, after changing the environment, because the original model is not suitable for a new environment, traditional AR technology cannot quickly realize the interaction between the virtual object and the real object.

In order to solve the problems in the prior art, an embodiment of the present application provides an animation display method, which will be described in detail with reference to the accompanying drawings in the specification.

In order to facilitate understanding of the technical solution provided by the embodiment of the present application, description will be firstly made with reference to the scene example shown in FIG. 1.

In order to realize the display effect of the tracks 21, 22 and 23, in the technical solution provided by the embodiment of the present application, the user can firstly move the terminal device along a motion trajectory 31, and trajectory parameters are collected by the terminal device during the motion process. Then, target models corresponding to various trajectory segments of the motion trajectory 31 can be determined according to the trajectory parameters, and the animation of the target models can be displayed at the corresponding display positions on the terminal device, so that the tracks 21, 22 and 23 can be displayed on the terminal device. The detailed process of determining the target model can be referred to the description of the embodiment corresponding to FIG. 2, which will not be repeated here.

FIG. 2 is a flowchart of an animation display method provided by an embodiment of the present application. The animation display method provided by the embodiment of the present application can be applied to an application scene in which the user creates an AR model and displays a corresponding animation through a terminal device. The method can be executed by an AR unit installed in the terminal device, and the unit can be implemented by means of software, the codes of which are integrated into a memory of the terminal device and executed by a processing unit of the terminal device. Optionally, the method can also be executed by a server or any other device with data processing function. In the following, the description is made by taking that the method is executed by the processing unit of the AR device as an example. As shown in FIG. 2, the method specifically includes the following steps:
S201: obtaining a trajectory parameter set corresponding to a target trajectory segment.

In order to create a target model corresponding to the target trajectory segment, the terminal device can be firstly moved along the target trajectory segment. During the process of the terminal device moving at the location corresponding to the target trajectory segment, the terminal device can collect a plurality of groups of trajectory parameters to obtain a trajectory parameter set. Optionally, each group of trajectory parameters can include a collection time and a collection location of this group of trajectory parameters. In some possible implementations, the trajectory parameters can further include a device orientation corresponding to the collection time.

In the following, each trajectory parameter and its collection method are firstly introduced.

During the process of the terminal device moving along the target trajectory segment, the terminal device can perform multiple times of data collection, and each time of collection can collect a plurality of parameters as one group of trajectory parameters. Optionally, the terminal device can perform data collection according to time intervals, that is, one group of trajectory parameters can be collected every preset time interval. Alternatively, the terminal device can collect according to distances, and one group of trajectory parameters can be collected every time the terminal device moves a preset distance.

When collecting trajectory parameters, the terminal device can record the time point of collecting this group of trajectory parameters as the collection time. Optionally, the terminal device can read the time point of collecting the trajectory parameters from the system as the collection time in the trajectory parameters. Alternatively, the terminal device can take the time stamp when collecting the trajectory parameters as the collection time in the trajectory parameters.

When the terminal parameter is at the starting point of the target trajectory segment, the terminal device can record its current location. For example, the terminal device can establish a coordinate system fixedly connected to the earth and record its current position as the origin of the coordinate system. During the process of moving along the target trajectory segment, the terminal device can determine the movement distance of the terminal device through its own sensors such as a gyroscope and an accelerometer, etc.; the movement distance of the terminal device can be determined through the acceleration measured by the accelerometer, and the rotation angle of the terminal device can be determined through the angular acceleration measured by the gyroscope. It can be seen that the location and orientation of the terminal device at any time point during the moving process can be determined by combining the measurement results of the gyroscope and the accelerometer. In this way, when collecting the trajectory parameters, the device orientation corresponding to the collection location and collection time of the terminal device and can be determined according to the measurement results of the gyroscope and the accelerometer. Optionally, in some possible implementations, the terminal device can also determine the collection location and device orientation corresponding to the collection time in other ways.

In some possible implementations, the collection location can be represented by three-dimensional coordinates, and the device orientation can be represented by a three-dimensional vector or a spatial quaternion.

In some possible implementations, the target trajectory segment can be freely selected by the user according to the model would like to be created. For example, assuming that the user wants to create a “ladder” type model that moves from the ground to the desktop, the user can hold the terminal device to move from the ground to the desktop. Assuming that the user wants to create a “lawn” type model that moves from one corner of the desktop to another corner, the user can hold the terminal device to move from one corner of the desktop to another corner. Optionally, during the process of the terminal device moving along the target trajectory segment, the user can adjust the parameters, such as the moving velocity and device orientation of the terminal, etc., according to an animation generation rule. The description of the animation generation rule can be referred to the following, which will not be repeated here.

In the embodiment of the present application, the movement trajectory of the terminal device can be called a target trajectory, and the target trajectory can include one or more target trajectory segments. On each target trajectory segment, the motion state feature of the terminal device remains basically unchanged. Optionally, the user can manually divide the target trajectory into a plurality of target trajectory segments. For example, the user can trigger a segmentation instruction by triggering a segmentation control displayed on the terminal device. After receiving the segmentation instruction triggered by the user, the terminal device can divide the trajectory before receiving the segmentation instruction into one target trajectory segment. In this way, the user can divide the motion trajectory of the terminal device into a plurality of target trajectory segments by triggering the segmentation instruction through the segmentation control. Because the target models corresponding to different target trajectory segments are independent of each other, the final target trajectory can be composed of multiple target models, thus realizing the combination of various animations.

For example, at the starting point of the target trajectory segment, the user can trigger a first instruction, so as to control the terminal device to start collecting trajectory parameters. At the end point of the target trajectory segment, the user can trigger a second instruction, so as to control the terminal device to stop collecting trajectory parameters. The first instruction and the second instruction can be the segmentation instructions mentioned above, and can also be the instruction to start collection or the instruction to stop collection. The trajectory parameters collected by the terminal device between the time point of obtaining the first instruction and the time point of obtaining the second instruction form the trajectory parameter set of the target trajectory segment.

In order to determine the collection location of any trajectory parameter in the trajectory parameter set, the terminal device can store the location when the first instruction is obtained, and determine the collection location according to the motion information. For example, assuming that the trajectory parameter set includes a first trajectory parameter and the first trajectory parameter includes a first location, the terminal device can firstly determine the motion information of the terminal device through the gyroscope and the accelerometer. The motion information indicates the movement distance and direction of the terminal device in the process of moving from a second location to the first location. Then, the terminal device can determine the first location on the basis of the second location and in combination with the obtained motion information.

Alternatively, in some other possible implementations, the trajectory parameter set of the target trajectory can be firstly collected, and the corresponding motion parameters can be determined according to the trajectory parameter set to divide the target trajectory into a plurality of target trajectory segments. Specifically, because each target trajectory segment corresponds to one target model, the motion state feature of the terminal device on each target trajectory segment should remain unchanged. Therefore, according to the motion parameter, the variation rule of the motion state feature of the terminal device on the target trajectory can be determined, so that the target trajectory can be divided into a plurality of target trajectory segments. The description of the motion parameter can be referred to the following, which will not be repeated here.

In some possible implementations, the accuracy of sensors such as the accelerometer and the gyroscope of terminal device, etc., may be limited, resulting in that the directly collected trajectory parameters may not be accurate enough. Then, in order to improve the accuracy of the target trajectory segment, data cleaning can be performed on the trajectory adoption number set.

Optionally, the five-point smoothing method can be used to clean the trajectory parameters. For example, it is assumed that the i-th trajectory parameter in the trajectory parameter set is represented by pᵢ, and the i-th trajectory parameter after data cleaning is represented by pᵢ′. Then the data cleaning process can be as follows:

$${p}_{i}^{′} = \frac{1}{5} {\sum }_{i - 2}^{i + 2} {p}_{i} , ( i ∈ \vert 2 , n - 2 \vert ) ,$$

where n is the total number of trajectory parameters included in the trajectory parameter set.

According to the foregoing description, the animation generation method provided by the embodiment of the present application can be executed by the terminal device or the server. Assuming that the animation generation method provided by the embodiment of the present application is executed by the terminal device, the terminal device can firstly store the trajectory parameter set collected during the motion process of the target trajectory segment, and extract the trajectory parameter set from the memory when generating the animation corresponding to the target trajectory segment. Assuming that the animation generation method provided by the embodiment of the present application is executed by the terminal device, the terminal device can firstly store the trajectory parameter set collected during the motion process of the target trajectory segment. When the animation corresponding to the target trajectory segment needs to be generated, the server can obtain the trajectory parameter set from the terminal device. For example, the server can obtain the trajectory parameter set by sending a request to the terminal device, or the terminal device can actively push the trajectory parameter set to the service.
S202: determining a target model corresponding to the target trajectory segment according to the trajectory parameter set.

After obtaining the trajectory parameter set, a target model corresponding to the target trajectory segment can be determined according to the trajectory parameter set. Specifically, a motion parameter can be firstly determined according to the trajectory parameter set, and then a target model corresponding to the target trajectory segment can be determined according to the motion parameter. The motion parameter is configured to reflect the motion state feature of the terminal device on the target trajectory segment. The target model is a virtual model to be displayed on the target trajectory segment, which can include a virtual model, such as a track model, a lawn model, a bridge model and a ladder model, etc.

According to the foregoing description, the animation display method provided by the embodiment of the present application can be applied to the terminal device or the server. Hereinafter, taking that the animation display method provided by the embodiment of the present application is executed by the terminal device as an example, the above two processes are described, respectively.

Firstly, the process of determining the motion parameter by the terminal device according to trajectory parameter set is introduced.

In the embodiment of the present application, the terminal device can firstly determine the motion parameter of the terminal device on the target trajectory segment according to the trajectory parameter set. Specifically, the terminal device can analyze the motion process of the terminal device on the target trajectory segment according to the trajectory parameter set, so as to determine the motion parameter of the target trajectory segment.

Optionally, the motion parameter can include any one or more of an average motion velocity, an average trajectory direction, an average device orientation, a velocity cumulative variation parameter and a directional cumulative variation parameter, etc. The methods of determining these motion parameters by the terminal device are respectively introduced below.

In a first possible implementation, the motion parameter can include an average motion velocity. The average motion velocity reflects the average velocity of the terminal device on the target trajectory segment.

In the process of calculating the average motion velocity of the terminal device, the target trajectory segment can be firstly divided into a plurality of sub-trajectory segments according to the trajectory parameters, the starting point of each sub-trajectory segment corresponds to one group of trajectory parameters, and the end point of each sub-trajectory segment also corresponds to one group of trajectory parameters. Optionally, in some possible implementations, the collection point of the trajectory parameters is not included inside the sub-trajectory segment. Then, the moving velocity of the terminal device on each of the plurality of sub-trajectory segments can be calculated according to the collection location and collection time of the starting point of the sub-trajectory segment and the collection location and collection time of the end point of the sub-trajectory segment. After obtaining the moving velocity of the terminal device on each sub-trajectory segment, the average motion velocity of the terminal device can be obtained by averaging the moving velocities of the plurality of sub-trajectory segments.

Optionally, the above process can be expressed by the following formula:

$${a}_{1} = \frac{1}{n - 1} {\sum }_{n}^{2} \frac{‖ {p}_{i} - {p}_{i - 1} ‖}{{t}_{i} - {t}_{i - 1}} ,$$

where a₁ represents the average motion velocity of the terminal device on the target trajectory segment, n is the number of trajectory parameters in the trajectory parameter set, pᵢ represents the collection location included in the i-th trajectory parameter in the trajectory parameter set, tᵢ represents the collection time included in the i-th trajectory parameter in the trajectory parameter set. Optionally, because the collection location pᵢ can be the three-dimensional coordinates of the terminal device, when calculating the average velocity of the terminal device, two adjacent collection locations can be subtracted and modulus taken to obtain the linear distance between the two collection locations.

In a second possible implementation, the motion parameter can include an average trajectory direction. The average trajectory direction is the direction from the starting point of the target trajectory segment to the end point of the target trajectory segment, that is, the overall orientation of the target trajectory segment.

In the process of calculating the average trajectory direction, the terminal device can firstly extract the trajectory parameters corresponding to the starting point of the target trajectory segment and the trajectory parameters corresponding to the end point of the target trajectory segment from the trajectory parameter set, and then calculate the average trajectory direction according to the collection location corresponding to the starting point of the target trajectory segment and the collection location corresponding to the end point of the target trajectory segment.

For example, assuming that the collection location in the trajectory parameters is expressed in the form of three-dimensional coordinates, the collection location corresponding to the starting point of the target trajectory segment and the collection location corresponding to the starting point of the target trajectory segment can be converted into three-dimensional vectors, respectively. Then, the two calculated three-dimensional vectors can be subtracted and normalized, and the obtained result is a unit vector from the starting point of the target trajectory segment to the end point of the target trajectory segment, that is, the average trajectory direction.

Optionally, the above process can be expressed by the following formula:

$${a}_{2} = \frac{{p}_{begin} - {p}_{e n d}}{‖ {p}_{begin} - {p}_{e n d} ‖} ,$$

where a₂ represents the average trajectory direction of the target trajectory segment, p_{begin} represents the collection location corresponding to the starting point of the target trajectory segment, p_{end} represents the collection location corresponding to the end point of the target trajectory segment, and the meanings of the remaining symbols are the same as those described above, and will not be repeated here.

In a third possible implementation, the motion parameter further includes an average device orientation, and the average device orientation reflects the average direction of the terminal device on the target trajectory segment.

Similar to the process of calculating the average motion velocity, in the process of calculating the average device orientation, the terminal device can divide the target trajectory segment into a plurality of sub-trajectory segments according to the trajectory parameter set, calculate the average orientation of the terminal device on each sub-trajectory according to the device orientation, and then average the average orientations of the plurality of sub-trajectory segments, so as to obtain the average device orientation.

Optionally, assuming that the device orientation is represented by a quaternion, the above process can be expressed by the following formula:

$${a}_{3} = \frac{1}{n - 1} {\sum }_{n}^{1} to Euler ( {q}_{i} ) ,$$

where a₃ represents the average device orientation of the terminal device on the target trajectory segment, n is the number of trajectory parameters in the trajectory parameter set, qᵢ represents the device orientation included in the i-th trajectory parameter in the trajectory parameter set, toEuler represents the calculation process of converting the quaternion into Euler angles, and the meanings of the remaining symbols are the same as those described above, and will not be repeated here.

In a fourth possible implementation, the motion parameter can further include a velocity cumulative variation parameter. The cumulative velocity variation parameter reflects the velocity fluctuation of the terminal device on the target trajectory segment.

Similar to the process of calculating the average motion velocity, in the process of calculating the average device orientation, the terminal device can divide the target trajectory segment into a plurality of sub-trajectory segments according to the trajectory parameter set, and calculate the velocity of the terminal device at each collection location according to the collection location and the collection time, and then calculate, according to the average velocity at two adjacent collection locations, the average acceleration corresponding to the sub-trajectory segment between the two adjacent collection locations, and finally average the plurality of average accelerations to obtain an average value, so that the velocity cumulative variation parameter is obtained.

Specifically, assuming that the collection location is expressed by three-dimensional coordinates, the above process can be expressed by the following formulas:

$$\begin{matrix}{v}_{i} = \frac{1}{2} ( \frac{‖ {p}_{i} - {p}_{i - 1} ‖}{{t}_{i} - {t}_{i - 1}} + \frac{‖ {p}_{i + 1} - {p}_{i} ‖}{{t}_{i + 1} - {t}_{i}} ) , \\ {a}_{4} = \frac{1}{n - 1} {\sum }_{n}^{2} \frac{\vert {v}_{i} - {v}_{i - 1} \vert}{{t}_{i} - {t}_{i - 1}} ,\end{matrix}$$

where vᵢ represents the velocity of the terminal device at the i-th trajectory parameter, a₄ represents the parameter of the velocity fluctuation of the terminal device on the target trajectory segment, and the meanings of the remaining symbols are the same as those described above, and will not be repeated here.

In a fifth possible implementation, the motion parameter includes a directional cumulative variation parameter. The directional cumulative variation parameter reflects the variation of the orientation of the terminal device on the target trajectory segment.

Similar to the process of calculating the average device orientation, in the process of calculating the directional cumulative variation parameter, the terminal device can divide the target trajectory segment into a plurality of sub-trajectory segments according to the trajectory parameter set, and calculate the rotation angle and rotation speed of the terminal device on each sub-trajectory according to the device orientation, and then average the rotation speeds of the plurality of sub-trajectory segments, so as to obtain the directional cumulative variation parameter.

Specifically, assuming that the device orientation is represented by a quaternion or vector, the above process can be represented by the following formula:

$${a}_{5} = \frac{1}{n - 1} {\sum }_{n}^{2} \frac{‖ {q}_{i} - {q}_{i - 1} ‖}{{t}_{i} - {t}_{i - 1}} ,$$

where a₅ represents the directional cumulative variation parameter of the terminal device on the target trajectory segment, and the meanings of the remaining symbols are the same as those described above, and will not be repeated here.

It should be noted that the five motion parameters given above are only examples, it does not mean that the animation display method provided by the embodiment of the present application merely includes these five motion parameters. In practical application scenarios, technicians can freely select any one or more motion parameters according to actual situations, or add other motion parameters that can reflect the motion state feature of the terminal device on the target trajectory segment.

The process of determining the motion parameter by the terminal device is described above, and the process of determining the target model by the terminal device according to the motion parameter is described below.

After the motion parameter is calculated, the terminal device can determine the target model corresponding to the target trajectory segment according to the motion parameter. Optionally, the terminal device can select a target model corresponding to the motion parameter from a model base according to the motion parameter. The model base can include a plurality of types of models, and each model corresponds to one animation display effect.

Before the user moves the medium-end device, the animation generation rule for generating the target model can be shown to the user. The animation generation rule is used to indicate a corresponding relationship between the motion state features and the target models. In this way, assuming that the user wants to generate a desired first model on the target trajectory segment, the user can determine a motion state feature corresponding to the first model according to the animation generation rule, and move the terminal device according to the motion state feature. In this way, after obtaining the trajectory parameter set collected by the terminal device during the motion process, the motion parameter can be obtained according to the trajectory parameter set, the motion state feature of the terminal device on the target trajectory segment can be deduced reversely, and the first model that the user wants to generate on the target trajectory segment can be determined in combination with the preset trajectory. In this way, by determining the first model as the target model, the animation effect corresponding to the first model can be displayed on the target trajectory segment. In the embodiment of the present application, the animation generation rule can be defined by technicians themselves according to actual situations.

The motion parameter can include any one or more of the average motion velocity, the average trajectory direction, the average device orientation, the velocity cumulative variation parameter and the directional cumulative variation parameter, etc. The methods of determining the target model by the terminal device according to these motion parameters are respectively introduced below.

In a first possible implementation, the motion parameter can include the average motion velocity.

In the process of determining the target model, the terminal device can judge size between the average motion velocity and an average velocity threshold. Assuming that the average motion velocity is greater than the average velocity threshold, it means that the terminal device moves faster on the target trajectory segment, then an accelerated motion model can be selected from the model base as the target model. Optionally, the accelerated motion model can include a model, such as an acceleration bar, a conveyor belt, etc.

In a second possible implementation, the motion parameter can include the average trajectory direction.

In the process of determining the target model, the terminal device can judge whether the component of the average trajectory direction in a vertical direction is greater than a rising threshold. Assuming that the component of the average trajectory direction in the vertical direction is less than or equal to the rising threshold, it means that the rising range of the target trajectory segment is small, and then a horizontal movement model can be selected from the model base as the target model corresponding to the target trajectory segment. Assuming that the component of the average trajectory direction in the vertical direction is greater than the rising threshold, it means that the rising range of the target trajectory segment is large, and then a vertical movement model can be selected from the model base as the target model corresponding to the target trajectory segment.

Optionally, the rising threshold can be, for example, \sqrt{2}/2, indicating that the rising angle of the target trajectory segment is greater than 45 degrees. The horizontal movement model can include a model, such as a horizontal road, a gentle slope road, and a horizontal acceleration belt, etc. The vertical movement model can include a model, such as a ladder, a lift, and a climbing rope, etc.

In a third possible implementation, the motion parameter can include the average trajectory direction and the average device orientation, and the animation generation rule can include “assuming that you want to generate an animation corresponding to a preset model, keep the terminal device in a tilted state and move a corresponding distance”.

In the process of determining the target model, the terminal device can judge whether the included angle between the average trajectory direction and the average device orientation is greater than an angle threshold. Assuming that the included angle between the average trajectory direction and the average device orientation is greater than the angle threshold, it means that the user tilts the terminal device when moving the terminal device, indicating that the user wants to display the animation corresponding to the preset model on the target trajectory segment. Then, the terminal device can determine that the target model corresponding to the target trajectory segment is the preset model. Optionally, the preset model can include a model, such as a bridge model, and a speed bump model, etc.; and the angle threshold can be, for example, \sqrt{2}/2.

In a fourth possible implementation, the motion parameter can include the velocity cumulative variation parameter.

In the process of determining the target model, the terminal device can compare the velocity cumulative variation parameter and a velocity fluctuation threshold. Assuming that the velocity cumulative variation parameter is greater than the velocity fluctuation threshold, it means that the velocity fluctuation of the terminal device is large on the target trajectory segment, and then a velocity fluctuation model can be selected from the model base as the target model. Optionally, the velocity fluctuation model can include a model, such as a road model with a roadblock.

In a fifth possible implementation, the motion parameter can include the directional cumulative variation parameter, and the animation generation rule can include “Assuming that you want to generate an animation corresponding to a preset model, rotate the terminal device while moving”.

In the process of determining the target model, the terminal device can judge whether the directional cumulative variation parameter is greater than a directional fluctuation threshold. Assuming that the directional cumulative variation parameter is greater than the directional fluctuation threshold, it means that the user is moving the terminal device while rotating it, indicating that the user wants to display the animation corresponding to the preset model on the target trajectory segment. Then, the terminal device can determine that the target model corresponding to the target trajectory segment is the preset model. Optionally, the preset model can include a model, such as a bridge model, and a speed bump model, etc.

It should be noted that the corresponding relationship between the motion parameters and the target models can be obtained according to the animation generation rule. In practical application scenarios, technicians can set an animation generation rule or adjust the animation generation rule according to actual needs.

In some possible implementations, the target model corresponding to the motion parameter can be determined by semantic mapping. Specifically, a corresponding relationship between motion parameters and semantic features, and a corresponding relationship between semantic features and target models can be established, respectively. Then, when determining the target model, the semantic feature corresponding to the motion parameter can be firstly determined according to the corresponding relationship between motion parameters and semantic features, and then the target model corresponding to the semantic feature can be determined according to the corresponding relationship between semantic features and target models. Each motion parameter can correspond to one or more semantic features. In this way, in the case where the motion parameter includes a plurality of types of parameters, they can be mapped to a plurality of semantic features according to the corresponding relationship, and the target model can be determined more accurately.

In the implementations given above, the target model is determined by the terminal device according to the trajectory parameter set. In some other possible implementations, the above method can also be executed by a server. After the server determines the target model, the server can send an identifier of the target model to the terminal device, so that the terminal device can show the animation effect corresponding to the target model in the following steps.

According to the description in S201, the movement trajectory of the terminal device can include one or more target trajectory segments, and the motion state feature of the terminal device on each target trajectory segment remains unchanged. Then, before determining the target model, it can be firstly judged whether the target trajectory segment meets a trajectory generation condition according to the motion parameter. The trajectory generation condition include that the motion state feature of the terminal device remains unchanged on the target trajectory segment. Assuming that the motion parameter meets the trajectory generation condition, the target model can continue to be determined by the terminal device. Assuming that the motion parameter does not meet the trajectory generation condition, the target trajectory segment can be divided into a plurality of target sub-trajectory segments according to the motion parameter, and the target model corresponding to each target sub-trajectory segment can be determined. The motion state feature of the terminal device on each target sub-trajectory segment remains unchanged.
S203: displaying the animation corresponding to the target model at a display position corresponding to the target trajectory segment on the terminal device.

After determining the target model corresponding to the target trajectory segment, the animation corresponding to the target model can be displayed at the display position corresponding to the target trajectory segment on the terminal device. Specifically, assuming that the method provided by the embodiment of the present application is executed by the terminal device, the terminal device can display the animation corresponding to the target model on its own display device or on a display device connected thereto. Optionally, the terminal device can use traditional AR technology to determine the display position corresponding to the target trajectory segment, and display the animation effect corresponding to the target model at the corresponding display position.

Assuming that the method provided by the embodiment of the present application is executed by a server, the server can send an identifier of the target model or an identifier of the animation effect corresponding to the target model to the terminal device, so that the terminal device can display the animation corresponding to the target model on its own display device or a display device connected thereto.

For example, in one possible implementation, the display effect of the terminal device can be as shown in FIG. 3. In the implementation shown in FIG. 3, the path 311, the bridge 312, the path 313, the ladder 314 and the bridge 315 are virtual display effects. The object 321, the desktop 322, the object 323 and the object 324 actually exist. In this way, the display effect of the virtual object being attached to the real object is realized.

In the animation display method provided by the embodiment of the present application, the terminal device can be firstly moved along the target trajectory segment by the user. Then, the trajectory parameter set collected by the terminal device on the target trajectory segment can be obtained. The trajectory parameter set can include a plurality of groups of trajectory parameters. And then, the target model can be displayed at the display position corresponding to the target trajectory segment on the terminal device. In this way, because the display position of the target model is determined according to the target trajectory segment that the terminal device has moved along and the terminal device will be constrained by the real object during the moving process, the animation of the target model will also be constrained by the real object. In this way, without modeling the real object, a corresponding virtual model can be created based on the real object, and the interaction between the virtual object and the real object is realized. In addition, because the target model is determined according to the trajectory parameters of the target trajectory segment, the user only needs to adjust the movement of the terminal device on the target trajectory segment to adjust the animation display effect corresponding to the target trajectory segment. In this way, the user's free choice of virtual animation is realized, and the user experience is improved.

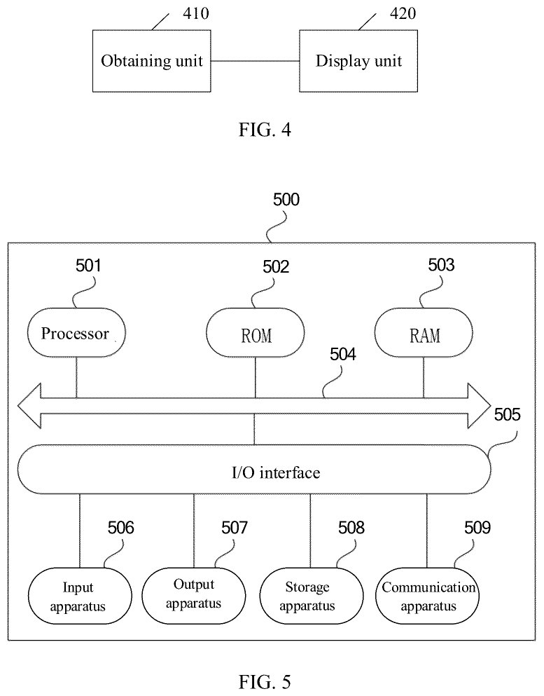

FIG. 4 is a schematic structural diagram of an animation display apparatus provided by an embodiment of the present application. The present embodiment can be applied to a scene where an AR effect is displayed by a terminal device. The animation display apparatus 400 specifically includes an obtaining module 410 and a display module 420.

Specifically, the obtaining unit 410 is configured to obtain a trajectory parameter set corresponding to a target trajectory segment, wherein the target trajectory segment is a trajectory segment passed by a terminal device during a motion process, the trajectory parameter set comprises a plurality of groups of trajectory parameters, and the trajectory parameters are collected by the terminal device during motion of the target trajectory segment.

The display unit 420 is configured to display an animation corresponding to a target model at a display position corresponding to the target trajectory segment on the terminal device, wherein the target model is determined according to a motion parameter, the motion parameter is determined according to the trajectory parameter set, and the motion parameter reflects a motion state feature of the terminal device on the target trajectory segment.

The animation display apparatus provide by the embodiment of the present application can execute the animation display method provided by any embodiment of the present application, and has corresponding functional units for executing the animation display method and corresponding beneficial effects.

Referring to FIG. 5, which shows a structural schematic diagram of an electronic device (e.g., a terminal device or a server running a software program) 500 suitable for implementing an embodiment of the present disclosure. The terminal device in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), and fixed terminals such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device includes a processor (such as a central processing unit, a graphics processor, etc.) 501, which may perform various appropriate actions and processes according to a program stored in a read-only memory (ROM) 502 or a program loaded from a storage device 508 into a random access memory (RAM) 503. In the RAM 503, various programs and data required for the operation of the electronic device 500 are also stored. A processor 501, a ROM 502 and a RAM 503 are connected to each other through a bus 504. An input/output (I/O) interface 1005 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in FIG. 2. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The electronic device provided by the embodiment of the present disclosure belongs to the same inventive concept as the animation display method provided by the above embodiment, and the technical details not described in detail in the embodiment of the present disclosure can be found in the above embodiment, and the embodiment of the present disclosure has the same beneficial effects as the above embodiment. An embodiment of the present disclosure provides a computer storage medium, on which a computer program is stored, characterized in that the program, when executed by a processor, realizes the animation display method in the embodiments as mentioned above.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate and interconnect with digital data in any form or medium. Examples of communication networks include a local area network (LAN), a wide area network (WAN), the Internet work (e.g., Internet), and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
obtaining a trajectory parameter set corresponding to a target trajectory segment, wherein the target trajectory segment is a trajectory segment passed by a terminal device during a motion process, the trajectory parameter set comprises a plurality of groups of trajectory parameters, and the trajectory parameters are collected by the terminal device during motion of the target trajectory segment; displaying an animation corresponding to a target model at a display position corresponding to the target trajectory segment on the terminal device, wherein the target model is determined according to a motion parameter, the motion parameter is determined according to the trajectory parameter set, and the motion parameter reflects a motion state feature of the terminal device on the target trajectory segment.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments, [example 1] provides an animation display method, the animation display method includes:
obtaining a trajectory parameter set corresponding to a target trajectory segment, wherein the target trajectory segment is a trajectory segment passed by a terminal device during a motion process, the trajectory parameter set includes a plurality of groups of trajectory parameters, and the trajectory parameters are collected by the terminal device during motion of the target trajectory segment;
displaying an animation corresponding to a target model at a display position corresponding to the target trajectory segment on the terminal device, wherein the target model is determined according to a motion parameter, the motion parameter is determined according to the trajectory parameter set, and the motion parameter reflects a motion state feature of the terminal device on the target trajectory segment.

According to one or more embodiments, [example 2] provides an animation display method, the animation display method further includes:
obtaining a first instruction triggered by a user and starting collecting the trajectory parameters;
obtaining a second instruction triggered by the user and stopping collecting the trajectory parameters;
wherein the first instruction is used to indicate a starting point of the target trajectory segment, and the second instruction is used to indicate an end point of the target trajectory segment.

According to one or more embodiments, [example 3] provides an animation display method, the animation display method further includes: optionally, the terminal device including a gyroscope and an accelerometer, the trajectory parameter set including a first trajectory parameter, the first trajectory parameter including a first location, and the starting collecting the trajectory parameters including:
obtaining a second location, wherein the second location is a location of the terminal device when the user triggers the first instruction;
determining motion information of the terminal device according to the gyroscope and the accelerometer;
determining the first location according to the second location and the motion information.

According to one or more embodiments, [example 4] provides an animation display method, the animation display method further includes: optionally, after obtaining the trajectory parameter set corresponding to the target trajectory segment, the method further including:
performing data cleaning on each group of trajectory parameter in the trajectory parameter set.

According to one or more embodiments, [example 5] provides an animation display method, the animation display method further includes: optionally, before displaying the animation corresponding to the target model at the display position corresponding to the target trajectory segment on the terminal device, the method further including:
determining the display position corresponding to the target trajectory segment according to the trajectory parameter set;
determine an animation effect corresponding to the target model.

According to one or more embodiments, [example 6] provides an animation display method, the animation display method further includes: optionally, before displaying the animation corresponding to the target model at the display position corresponding to the target trajectory segment on the terminal device, the method further including:
determining the motion parameter according to the trajectory parameter set;
selecting a target model corresponding to the motion parameter from a model base, wherein the model base includes a plurality of types of models.

According to one or more embodiments, [example 7] provides an animation display method, the animation display method further includes: optionally, the trajectory parameters including a collection time and a collection location for the terminal device to collect the trajectory parameters, the motion parameter including an average motion velocity, and the average motion velocity reflecting an average velocity of the terminal device on the target trajectory segment;
the determining the motion parameter according to the trajectory parameter set including:
dividing the target trajectory segment into a plurality of sub-trajectory segments according to the collection time of the trajectory parameters;
calculating a moving velocity of the terminal device on each sub-trajectory segment according to a collection location and a collection time of a starting point and a collection location and a collection time of an end point of the each sub-trajectory segment;
determining the average motion velocity according to the moving velocity of each sub-trajectory segment among the plurality of sub-trajectory segments;
the selecting the target model corresponding to the motion parameter from the model base including:
selecting, in response that the average motion velocity is greater than an average velocity threshold, an accelerated moving motion model from the model base as the target model corresponding to the target trajectory segment.

According to one or more embodiments, [example 8] provides an animation display method, the animation display method further includes: optionally, the trajectory parameters including a collection location for the terminal device to collect the trajectory parameters, the motion parameter including an average trajectory direction, and the average trajectory direction being a direction from a starting point of the target trajectory segment to an end point of the target trajectory segment;
the determining the motion parameter according to the trajectory parameter set including:
calculating the average trajectory direction according to a collection location of the starting point of the target trajectory segment and a collection location of the end point of the target trajectory segment;
the selecting the target model corresponding to the motion parameter from the model base including:
selecting, in response that a component of the average trajectory direction in a vertical direction is less than or equal to a rising threshold, a horizontal movement model from the model base as the target model corresponding to the target trajectory segment;
selecting, in response that the component of the average trajectory direction in the vertical direction is greater than the rising threshold, a vertical movement model from the model base as the target model corresponding to the target trajectory segment.

According to one or more embodiments, [example 9] provides an animation display method, the animation display method further includes: optionally, the trajectory parameters further including a device orientation of the terminal device when the terminal device collects the trajectory parameters, the motion parameter further including an average device orientation, and the average device orientation reflecting an average direction of the terminal device on the target trajectory segment;
the determining the motion parameter according to the trajectory parameter set comprises:
averaging a plurality of device orientations included in the trajectory parameter set to obtain the average device orientation;
the selecting the target model corresponding to the motion parameter from the model base comprises:
selecting, in response that an included angle between the average device orientation and the average trajectory direction is greater than an angle threshold, a preset model from the model base as the target model corresponding to the target trajectory segment according to an animation generation rule, wherein the animation generation rule indicates a corresponding relationship between the terminal device in tilting motion and an animation corresponding to the preset model.

According to one or more embodiments, [example 10] provides an animation display method, the animation display method further includes: optionally, the trajectory parameters including a collection time and a collection location for the terminal device to collect the trajectory parameters, the motion parameter including a velocity cumulative variation parameter, and the velocity cumulative variation parameter reflecting a velocity fluctuation of the terminal device on the target trajectory segment;
the determining the motion parameter according to the trajectory parameter set including:
calculating a corresponding velocity of the terminal device at each collection location according to the trajectory parameter set;
calculating the velocity cumulative variation parameter according to the corresponding velocity of the terminal device at each collection location;
the selecting the target model corresponding to the motion parameter from the model base including:
selecting, in response that the velocity cumulative variation parameter is greater than a velocity fluctuation threshold, a velocity fluctuation model from the model base as the target model corresponding to the target trajectory segment.

According to one or more embodiments, [example 11] provides an animation display method, the animation display method further includes: optionally, before determining the target model according to the motion parameter, the method further including:
determining, according to the motion parameter, that the target trajectory segment meets a trajectory generation condition, wherein the trajectory generation condition includes that the motion state feature of the terminal device remains unchanged.

According to one or more embodiments, [example 12] provides an animation display apparatus, including:
an obtaining unit, configured to obtain a trajectory parameter set corresponding to a target trajectory segment, wherein the target trajectory segment is a trajectory segment passed by a terminal device during a motion process, the trajectory parameter set includes a plurality of groups of trajectory parameters, and the trajectory parameters are collected by the terminal device during motion of the target trajectory segment;
a display unit, configured to display an animation corresponding to a target model at a display position corresponding to the target trajectory segment on the terminal device, wherein the target model is determined according to a motion parameter, the motion parameter is determined according to the trajectory parameter set, and the motion parameter reflects a motion state feature of the terminal device on the target trajectory segment.

According to one or more embodiments, [example 13] provides an electronic device, the electronic device includes: one or more processors; a memory, configured to storing one or more programs; the one or more programs, when executed by the one or more processors, cause the one or more processors to realize the animation display method according to any embodiment of the present application.

According to one or more embodiments, [example 14] provides a computer-readable storage medium, on which a computer program is stored, the program, when executed by a processor, realizes the animation display method according to any embodiment of the present application.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

1. An animation display method, characterized in that the method comprises:
obtaining a trajectory parameter set corresponding to a target trajectory segment, wherein the target trajectory segment is a trajectory segment passed by a terminal device during a motion process, the trajectory parameter set comprises a plurality of groups of trajectory parameters, and the trajectory parameters are collected by the terminal device during motion of the target trajectory segment;
displaying an animation corresponding to a target model at a display position corresponding to the target trajectory segment on the terminal device, wherein the target model is determined according to a motion parameter, the motion parameter is determined according to the trajectory parameter set, and the motion parameter reflects a motion state feature of the terminal device on the target trajectory segment.

2. The method according to claim 1, characterized in that the method is applied to the terminal device, and further comprises:
obtaining a first instruction triggered by a user and starting collecting the trajectory parameters;
obtaining a second instruction triggered by the user and stopping collecting the trajectory parameters;
wherein the first instruction is used to indicate a starting point of the target trajectory segment, and the second instruction is used to indicate an end point of the target trajectory segment.

3. The method according to claim 2, characterized in that the terminal device comprises a gyroscope and an accelerometer, the trajectory parameter set comprises a first trajectory parameter, the first trajectory parameter comprises a first location, and the starting collecting the trajectory parameters comprises:
obtaining a second location, wherein the second location is a location of the terminal device when the user triggers the first instruction;
determining motion information of the terminal device according to the gyroscope and the accelerometer;
determining the first location according to the second location and the motion information.

4. The method according to claim 1, characterized in that after obtaining the trajectory parameter set corresponding to the target trajectory segment, the method further comprises:
performing data cleaning on each group of trajectory parameter in the trajectory parameter set.

5. The method according to claim 1, characterized in that before displaying the animation corresponding to the target model at the display position corresponding to the target trajectory segment on the terminal device, the method further comprises:
determining the display position corresponding to the target trajectory segment according to the trajectory parameter set;
determine an animation effect corresponding to the target model.

6. The method according to claim 1, characterized in that before displaying the animation corresponding to the target model at the display position corresponding to the target trajectory segment on the terminal device, the method further comprises:
determining the motion parameter according to the trajectory parameter set;
selecting a target model corresponding to the motion parameter from a model base, wherein the model base comprises a plurality of types of models.

7. The method according to claim 6, characterized in that the trajectory parameters comprise a collection time and a collection location for the terminal device to collect the trajectory parameters, the motion parameter comprises an average motion velocity, and the average motion velocity reflects an average velocity of the terminal device on the target trajectory segment;
the determining the motion parameter according to the trajectory parameter set comprises:
dividing the target trajectory segment into a plurality of sub-trajectory segments according to the collection time of the trajectory parameters;
calculating a moving velocity of the terminal device on each sub-trajectory segment according to a collection location and a collection time of a starting point and a collection location and a collection time of an end point of the each sub-trajectory segment;
determining the average motion velocity according to the moving velocity of each sub-trajectory segment among the plurality of sub-trajectory segments;
the selecting the target model corresponding to the motion parameter from the model base comprises:
selecting, in response that the average motion velocity is greater than an average velocity threshold, an accelerated moving model from the model base as the target model corresponding to the target trajectory segment.

8. The method according to claim 6, characterized in that the trajectory parameters comprise a collection location for the terminal device to collect the trajectory parameters, the motion parameter comprises an average trajectory direction, and the average trajectory direction is a direction from a starting point of the target trajectory segment to an end point of the target trajectory segment;
the determining the motion parameter according to the trajectory parameter set comprises:
calculating the average trajectory direction according to a collection location of the starting point of the target trajectory segment and a collection location of the end point of the target trajectory segment;
the selecting the target model corresponding to the motion parameter from the model base comprises:
selecting, in response that a component of the average trajectory direction in a vertical direction is less than or equal to a rising threshold, a horizontal movement model from the model base as the target model corresponding to the target trajectory segment;
selecting, in response that the component of the average trajectory direction in the vertical direction is greater than the rising threshold, a vertical movement model from the model base as the target model corresponding to the target trajectory segment.

9. The method according to claim 8, wherein the trajectory parameters further comprise a device orientation of the terminal device when the terminal device collects the trajectory parameters, the motion parameter further comprises an average device orientation, and the average device orientation reflects an average direction of the terminal device on the target trajectory segment;
the determining the motion parameter according to the trajectory parameter set comprises:
averaging a plurality of device orientations included in the trajectory parameter set to obtain the average device orientation;
the selecting the target model corresponding to the motion parameter from the model base comprises:
selecting, in response that an included angle between the average device orientation and the average trajectory direction is greater than an angle threshold, a preset model from the model base as the target model corresponding to the target trajectory segment according to an animation generation rule, wherein the animation generation rule indicates a corresponding relationship between the terminal device in tilting motion and an animation corresponding to the preset model.

10. The method according to claim 6, characterized in that the trajectory parameters comprise a collection time and a collection location for the terminal device to collect the trajectory parameters, the motion parameter comprises a velocity cumulative variation parameter, and the velocity cumulative variation parameter reflects a velocity fluctuation of the terminal device on the target trajectory segment;
the determining the motion parameter according to the trajectory parameter set comprises:
calculating a corresponding velocity of the terminal device at each collection location according to the trajectory parameter set;
calculating the velocity cumulative variation parameter according to the corresponding velocity of the terminal device at each collection location;
the selecting the target model corresponding to the motion parameter from the model base comprises:
selecting, in response that the velocity cumulative variation parameter is greater than a velocity fluctuation threshold, a velocity fluctuation model from the model base as the target model corresponding to the target trajectory segment.

11. The method according to claim 1, characterized in that before determining the target model according to the motion parameter, the method further comprises:
determining, according to the motion parameter, that the target trajectory segment meets a trajectory generation condition, wherein the trajectory generation condition comprises that the motion state feature of the terminal device remains unchanged.

12. An animation display apparatus, characterized in that the apparatus comprises:
an obtaining unit, configured to obtain a trajectory parameter set corresponding to a target trajectory segment, wherein the target trajectory segment is a trajectory segment passed by a terminal device during a motion process, the trajectory parameter set comprises a plurality of groups of trajectory parameters, and the trajectory parameters are collected by the terminal device during motion of the target trajectory segment;
a display unit, configured to display an animation corresponding to a target model at a display position corresponding to the target trajectory segment on the terminal device, wherein the target model is determined according to a motion parameter, the motion parameter is determined according to the trajectory parameter set, and the motion parameter reflects a motion state feature of the terminal device on the target trajectory segment.

13. An electronic device, characterized in that the electronic device comprises: one or more processors; a memory, configured to storing one or more programs; the one or more programs, when executed by the one or more processors, cause the one or more processors to realize the animation display method according to claim 1.

14. A computer-readable storage medium, on which a computer program is stored, characterized in that the program, when executed by a processor, realizes the animation display method according to claim 1.

15. The method according to claim 4, wherein a five-point smoothing method is used to clean the trajectory parameters.

16. The method according to claim 6, characterized in that the trajectory parameters further comprise a device orientation of the terminal device when the terminal device collects the trajectory parameters, the motion parameter further comprises a directional cumulative variation parameter, and the directional cumulative variation parameter reflects a variation of an orientation of the terminal device on the target trajectory segment;
the determining the motion parameter according to the trajectory parameter set comprises:
dividing the target trajectory segment into a plurality of sub-trajectory segments according to the trajectory parameter set;
calculating a rotation angle and a rotation speed of the terminal device on each sub-trajectory segment according to the device orientation;
averaging rotation speeds of the plurality of sub-trajectory segments, so as to obtain the directional cumulative variation parameter;
selecting the target model corresponding to the motion parameter from the model base comprises:
selecting, in response that the directional cumulative variation parameter is greater than a directional fluctuation threshold, a preset model from the model base as the target model corresponding to the target trajectory segment.

17. The method according to claim 2, characterized in that before displaying the animation corresponding to the target model at the display position corresponding to the target trajectory segment on the terminal device, the method further comprises:
determining the motion parameter according to the trajectory parameter set, wherein the motion parameter comprises any one or more of an average motion velocity, an average trajectory direction, an average device orientation, a velocity cumulative variation parameter and a directional cumulative variation parameter;
selecting a target model corresponding to the motion parameter from a model base, wherein the model base comprises a plurality of types of models.

18. The method according to claim 3, characterized in that before displaying the animation corresponding to the target model at the display position corresponding to the target trajectory segment on the terminal device, the method further comprises:
determining the motion parameter according to the trajectory parameter set, wherein the motion parameter comprises any one or more of an average motion velocity, an average trajectory direction, an average device orientation, a velocity cumulative variation parameter and a directional cumulative variation parameter;
selecting a target model corresponding to the motion parameter from a model base, wherein the model base comprises a plurality of types of models.

19. The method according to claim 4, characterized in that before displaying the animation corresponding to the target model at the display position corresponding to the target trajectory segment on the terminal device, the method further comprises:
determining the motion parameter according to the trajectory parameter set, wherein the motion parameter comprises any one or more of an average motion velocity, an average trajectory direction, an average device orientation, a velocity cumulative variation parameter and a directional cumulative variation parameter;
selecting a target model corresponding to the motion parameter from a model base, wherein the model base comprises a plurality of types of models.

20. The method according to claim 5, characterized in that before displaying the animation corresponding to the target model at the display position corresponding to the target trajectory segment on the terminal device, the method further comprises:
determining the motion parameter according to the trajectory parameter set, wherein the motion parameter comprises any one or more of an average motion velocity, an average trajectory direction, an average device orientation, a velocity cumulative variation parameter and a directional cumulative variation parameter,
selecting a target model corresponding to the motion parameter from a model base, wherein the model base comprises a plurality of types of models.
